(19) United States
(12) Patent Application Publication
(10) Pub. No.: US 2011/0310036 A1
(43) Pub. Date: Dec. 22, 2011

(54) TOUCH PANEL AND PIXEL ARAY THEREOF

(75) Inventors: Yi Chung JUAN, Tainan County (TW); Sung Chun LIN, Tainan City (TW); Chia Hua YU, New Taipei City (TW)

(73) Assignee: HANNSTAR DISPLAY CORP., New Taipei City (TW)

(21) Appl. No.: 13/097,695

(22) Filed: Apr. 29, 2011

(30) Foreign Application Priority Data
Jun. 18, 2010 (TW) 099119829

(51) Int. Cl. G06F 3/041

(52) U.S. Cl. 345/173

(57) ABSTRACT

A pixel array includes a plurality of pixels, data lines, readout lines and gate lines, wherein a data line and a readout line are alternatively disposed between every two adjacent pixels; two pixels adjacent to each data line are coupled to the same data line but coupled to different gate lines; and at least a part of the readout lines are coupled to one of the two pixels adjacent thereto. The present invention further provides a touch panel including the above pixel array.

### CROSS REFERENCE TO RELATED APPLICATION

This application claims the priority benefit of Taiwan Patent Application Serial Number 099119829, filed on Jun. 18, 2010, the full disclosure of which is incorporated herein by reference.

### BACKGROUND

1. Field of the Invention

This invention generally relates to a touch control device and, more particularly, to an in-cell touch panel and pixel array thereof.

2. Description of the Related Art

The liquid crystal display is a widely used display device in the present day. With the maturity of the touch screen technologies, various kinds of electronic devices, e.g. a multimedia player, a cell phone and a personal digital assistance (PDA), generally are adopted with a LCD touch screen to increase the using convenience thereof.

Conventional LCD touch screens include an external touch panel (or called touch sensor) attached in front of the LCD screen, so called add-on touch screen. Because resistive touch panels and capacitive touch panels have relatively simpler manufacturing processes and lower costs, they are widely applied in different end applications. However, since the external touch panel will increase a total thickness of the touch screen and lower the transparency of the display device thereby degrading the brightness performance thereof, an in-cell touch panel is then proposed to solve this problem.

Please refer to FIG. 1, it shows a schematic diagram of a pixel array 9 in a conventional in-cell touch panel. The pixel array 9 generally includes a plurality of sub-pixel groups each including a red sub-pixel R, a green sub-pixel G and a blue sub-pixel B, wherein the red sub-pixel R and the blue sub-pixel B do not include any touch sensing unit but the green sub-pixel G includes a touch sensing unit 90. The pixel array 9 includes a plurality of data lines 91 and a plurality of gate lines 92 to define the red sub-pixel R, the green sub-pixel G and the blue sub-pixel B, wherein three adjacent red sub-pixel R, green sub-pixel G and blue sub-pixel B sequentially arranged in a horizontal direction are defined as a sub-pixel group. As shown in FIG. 1, each sub-pixel group further includes a readout line 93 disposed in one sub-pixel area, e.g. inside the green sub-pixel G, for outputting a touch control signal read by the touch sensing unit 90. A pixel transistor 94 is configured to control the gray level data of the data line 91 to be inputted to a pixel electrode 95. As every sub-pixel group includes a readout line 93 disposed therein, it will decrease the pixel aperture ratio. Furthermore, if the detection resolution of the touch panel needs to be further improved, at least one touch sensing unit and a readout line coupled thereto have to be further added in every sub-pixel group, e.g. adding a touch sensing unit and a readout line (not shown) in the red sub-pixel R of every sub-pixel group, but the pixel aperture ratio will be further decreased. In addition, as both the readout line 93 and the data line 91 are disposed in the same pixel area (e.g. inside the green sub-pixel G) and parallel to each other within just a small distance therebetween, the coupling effect between these two conductive lines will distort the touch control signal thereby introducing misjudgment of the touch event from time to time.

Accordingly, it is necessary to provide a touch panel that has a higher aperture ratio than conventional in-cell touch panels and is able to reduce the coupling effect between the readout line and the date line.

### SUMMARY

The present invention provides a touch panel and pixel array thereof that may increase the aperture ratio of an in-cell touch panel.

The present invention further provides a touch panel with a dual gate line structure and pixel array thereof that may reduce the coupling effect between adjacent pixels thereby increasing the uniformity of the display.

The present invention provides a pixel array of a touch panel including a first pixel, a second pixel, a third pixel and a fourth pixel sequentially arranged along a horizontal direction, a first data line, a second data line, a readout line, a first gate line and a second gate line. The first data line extends along a vertical direction, and is disposed between and coupled to the first pixel and the second pixel. The second data line extends along the vertical direction, and is disposed between and coupled to the third pixel and the fourth pixel. The readout line extends along the vertical direction, is disposed between the second pixel and the third pixel and is coupled to at least one of the second pixel and the third pixel, wherein no data line is disposed between the second pixel and the third pixel. The first gate line is coupled to the first pixel and the third pixel. The second gate line is coupled to the second pixel and the fourth pixel.

The present invention further provides a pixel array of a touch panel including a plurality of pixels arranged in a matrix, a plurality of data lines disposed along a horizontal direction, a plurality of readout lines disposed parallel to the plurality of data lines and a plurality of gate lines disposed perpendicular to the plurality of data lines, wherein a data line and a readout line are alternatively disposed between every two adjacent pixels along the horizontal direction; two pixels adjacent to each data line are coupled to the same data line but coupled to different gate lines; and at least a part of the readout lines are coupled to one of the two pixels adjacent to the readout lines.

The present invention further provides a touch panel including a plurality of pixels arranged in a matrix, a plurality of gate lines, a gate driver coupled to the plurality of gate lines, a plurality of date lines and a plurality of readout lines. Every two pixels in a row along a horizontal direction form a pixel group and each pixel is coupled to one of the gate lines. The date lines are respectively disposed between two pixels of the pixel group, wherein the two pixels of each pixel group are coupled to the same data line but coupled to different gate lines. The readout lines are disposed between at least a part of two adjacent pixel groups, wherein a data line and a readout line are alternatively disposed between every two adjacent pixels along the horizontal direction, and at least a part of the readout lines are coupled to one of the two pixels adjacent to the readout line.

The pixel array of the present invention may be applicable to the in-cell touch panel driven by a gate driver or by gate drivers, such as a gate driver IC or an integrated gate driver.

In the touch panel and pixel array of the present invention, when one of the two pixels adjacent to the readout line is a blue sub-pixel, the readout line is coupled to the blue sub-pixel; and when one of the two pixels adjacent to the readout line is a green sub-pixel, the readout line is not coupled to the green sub-pixel. The pixel to which the readout line coupled further includes a touch sensing unit configured to sense a voltage variation (e.g. in a resistive touch panel or a contact type touch panel), a current variation (e.g. in a capacitive touch panel), a light intensity variation (e.g. in an optical touch panel) or a wave intensity variation (e.g. in an acoustic wave touch panel), wherein the readout line is coupled to the touch sensing unit for outputting a touch control signal. In addition, a read transistor may be further disposed between the readout line and the touch sensing unit, and the read transistor is controlled by the gate line to determine whether to output the touch control signal to the readout line.

### BRIEF DESCRIPTION OF THE DRAWINGS

Other objects, advantages, and novel features of the present invention will become more apparent from the following detailed description when taken in conjunction with the accompanying drawings.

FIG. 1 shows a schematic diagram of the pixel array of a conventional touch panel.

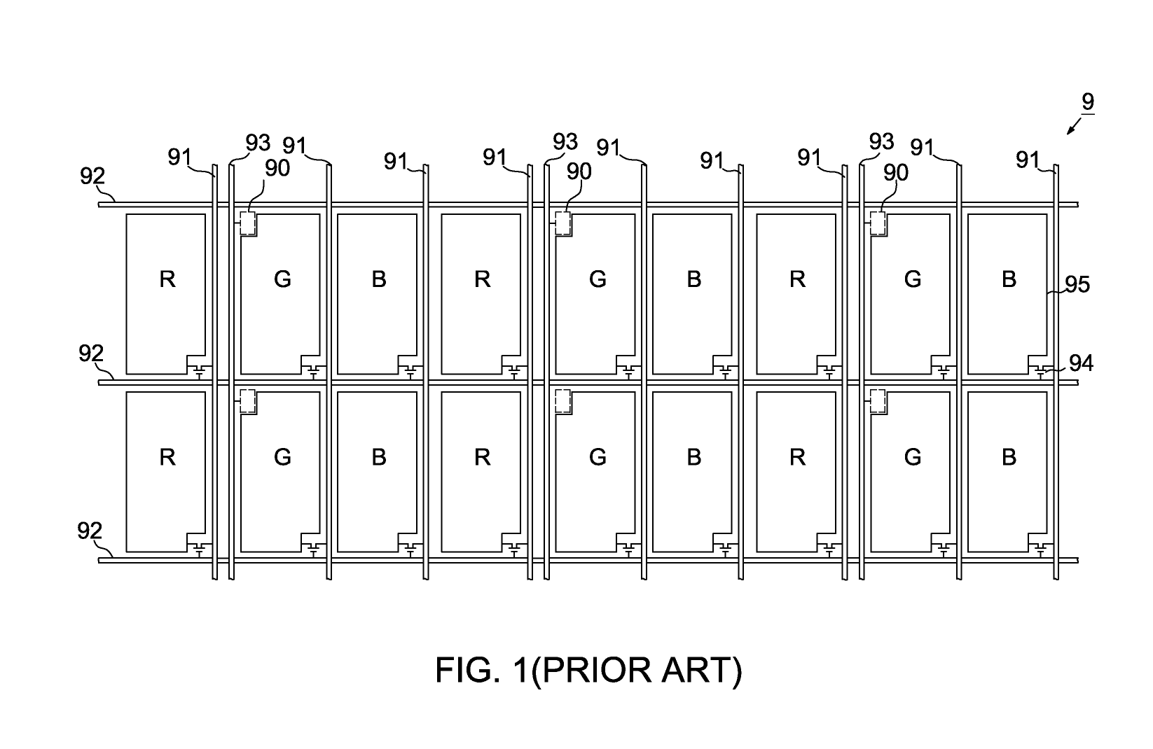

FIG. 2a shows a schematic diagram of the touch panel according to the first embodiment of the present invention.

FIG. 2b shows another schematic diagram of the touch panel according to the first embodiment of the present invention.

FIGS. 3a to 3b show schematic diagrams of the sensing unit in the touch panel according to the embodiment of the present invention.

FIG. 4 shows a schematic diagram of the touch panel according to the second embodiment of the present invention.

FIG. 5 shows another schematic diagram of the touch panel according to the second embodiment of the present invention.

### DETAILED DESCRIPTION OF THE EMBODIMENT

In the drawings of the present invention, only a part of the components are shown and other components that are not directly pertinent to the illustrations of the present invention will be omitted.

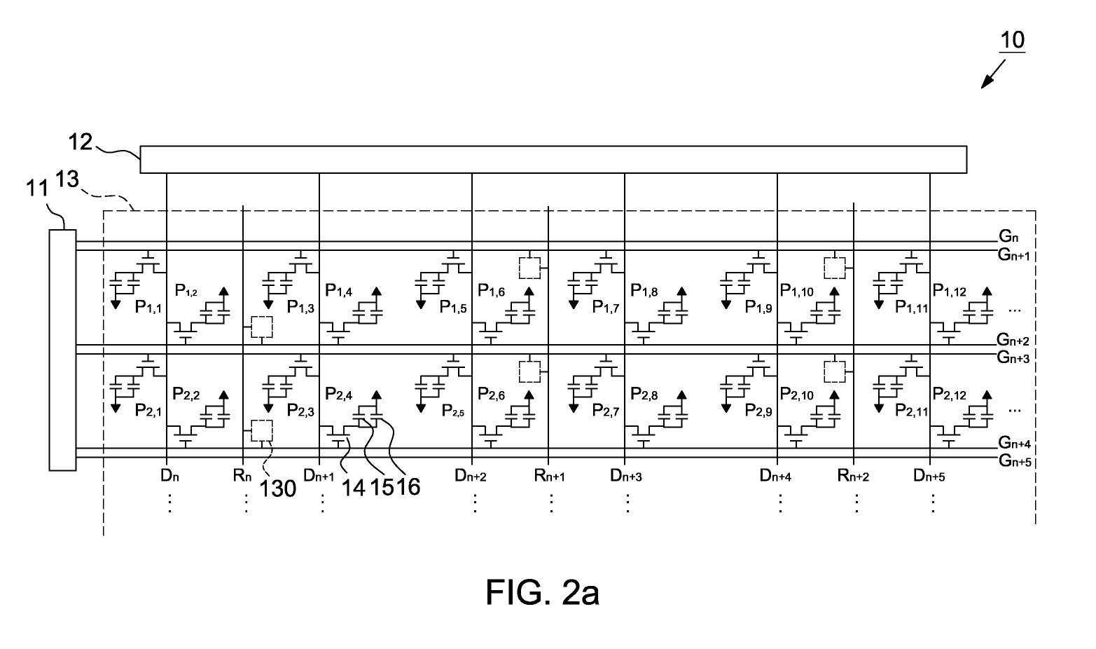

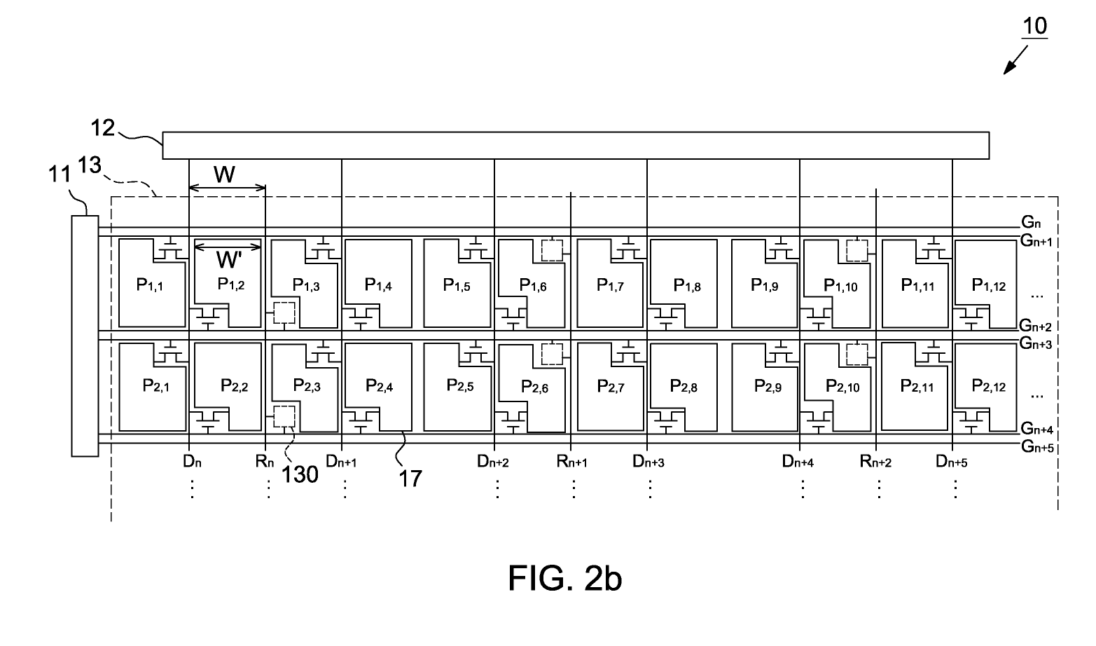

Please refer to FIGS. 2a and 2b, they show schematic diagrams of the touch panel 10 according to the first embodiment of the present invention, wherein FIG. 2a shows a circuit schematic diagram of the touch panel 10 of this embodiment and FIG. 2b further shows the pixel structure of every pixel shown in FIG. 2a. As shown in FIG. 2a, the touch panel 10 includes a gate driver 11, a source driver 12 and a pixel array 13, which is an active matrix. The gate driver 11 sequentially outputs, in a scan period, a scan signal to every row of pixels of the pixel array 13 through a plurality of gate lines Gₙ˜G₊₅ extending in a horizontal direction and arranged in parallel. The source driver 12 outputs the gray level data to be displayed to every column of pixels of the pixel array 13 through a plurality of data lines Dₙ˜Dₙ₊₅ extending in a vertical direction and arranged in parallel, wherein the horizontal direction and the vertical direction are defined according to FIGS. 2a and 2b. It is appreciated that, the gate driver 11 and the source driver 12 are controlled by a timing controller. The gate lines Gₙ˜G₊₅ and the data lines Dₙ˜D₊₅ are substantially perpendicular to each other to define the plurality of pixels of the pixel array 13.

The touch panel 10 further includes a plurality of readout lines Rₙ˜R₊₂ extending along the vertical direction and substantially parallel to the plurality of data lines Dₙ˜D₊₅ for outputting a touch control signal sensed by a sensing unit 130 coupled thereto. It is appreciated that, numbers of the gate lines Gₙ˜Gₙ₊₅, data lines Dₙ˜Dₙ₊₅, readout lines Rₙ˜Rₙ₊₂ and sensing units 130 shown in FIGS. 2a and 2b are only exemplary and the actual number thereof may be determined according to a size and resolution of the touch panel 10. A main feature of the touch panel 10 of the present invention is that, a total number of the gate lines G is twice of that of conventional touch panels while a total number of the data lines D is about a half of that of conventional touch panels, i.e. two adjacent pixels along the horizontal direction (e.g. the pixels P_{1,1} and P_{1,2} or the pixels P_{2,1} and P_{2,2} . . . etc.) share one data line to form a dual (double) gate line structure. Meanwhile, the present invention utilizes the space between adjacent pixels released due to the decrease of the data lines to dispose the readout lines R such that the aperture ratio of the touch panel 10 can be increased. Furthermore, in the present invention only one readout line or one data line is disposed between two adjacent pixels. In other word, any adjacent readout line and data line have a separation of one pixel width W so as to reduce the coupling effect between the readout line and the data line. That is, a pixel width W is equal to a distance between adjacent data line and readout line as shown in FIG. 2b.

The pixel array 13 includes a plurality of pixels arranged in a matrix, e.g. the pixels P_{1,1} to P_{1,12} are sequentially arranged along the horizontal direction; the pixels P_{2,1} to P_{2,12} are sequentially arranged along the horizontal direction . . . . In FIG. 2a, each pixel includes a pixel transistor 14, a liquid crystal capacitor 15 and an auxiliary capacitor 16, wherein the liquid crystal capacitor 15 is composed of two electrodes including a pixel electrode and a common electrode. A control terminal of the pixel transistor 14 is coupled to a gate line, a first terminal thereof is coupled to a data line and a second terminal thereof is coupled to the liquid crystal capacitor 15 and the auxiliary capacitor 16. FIG. 2b further shows the pixel electrode 17 which is one of the two electrodes forming the liquid crystal capacitor 15 of every pixel shown in FIG. 2a, wherein a control terminal of the pixel transistor 14 is coupled to a gate line, a first terminal thereof is coupled to a data line and a second terminal thereof is coupled to the pixel electrode 17; wherein a shape of the pixel electrode 17 is only exemplary rather than a limitation of the present invention. Taking the pixel P_{1,2} shown in FIG. 2b as an example, its boundaries are respectively defined by Dₙ, Rₙ, Gₙ₊₁ and Gₙ₊₂, wherein a pixel width of the pixel P_{1,2} is represented by W and a pixel electrode width of the pixel electrode 17 therein is represented by W′. In this embodiment, a pixel width of every pixel is W and a pixel electrode width of every pixel electrode 17 is W′. In addition, it is known from FIG. 2b that a distance between adjacent data line and readout line (e.g. between Dₙ and Rₙ) is equal to the pixel width W or larger than the pixel electrode width W′ of the pixel electrode 17. In this embodiment, every four adjacent pixels along the horizontal direction may be referred as a sub-pixel group, e.g. the pixels P_{1,1} to P_{1,4}, P_{1,5} to P_{1,8}, P_{1,9} to P_{1,12} . . . respectively referred as sub-pixel group.

This embodiment will be illustrated by taking one sub-pixel group as an example and the structure of other sub-pixel groups is identical thereto. For example in the sub-pixel group composed of the pixels P_{1,1} to P_{1,4}, a data line Dₙ is disposed between the pixels P_{1,1} and P_{1,2} and both of the pixels P_{1,1} and P_{1,2} are coupled to the data line Dₙ. For example, the first terminals of the pixel transistors 14 of the pixels P_{1,1} and P_{1,2} are both coupled to the same data line Dₙ, i.e. the pixels P_{1,1} and P_{1,2} share the data line Dₙ and are respectively controlled by different gate lines Gₙ₊₁ and Gₙ₊₂ for pixel data writing. Similarly, a data line Dₙ₊₁ is disposed between the pixels P_{1,3} and P_{1,4} and both of the pixels P_{1,3} and P_{1,4} are coupled to the data line Dₙ₊₁. For example, the first terminals of the pixel transistors 14 of the pixels P_{1,3} and P_{1,4} are coupled to the same data line Dₙ₊₁, i.e. the pixels P_{1,3} and P_{1,4} share the data line Dₙ₊₁ and are respectively controlled by different gate lines Gₙ₊₁ and Gₙ₊₂ for pixel data writing. As the pixels P_{1,1} and P_{1,2} share the same data line Dₙ and the pixels P_{1,3} and P_{1,4} share the same data line Dₙ₊₁ for pixel data writing, no data line is required to be disposed between the pixels P_{1,2} and P_{1,3}. In this way, a readout lint Rₙ may further be disposed between the pixels P_{1,2} and P_{1,3} so as to reduce the impact of the readout line Rₙ on the aperture ratio. As shown in FIGS. 2a and 2b, the readout line Rₙ is coupled to the sensing unit of at least one of two pixels adjacent thereto. For example in FIG. 2a, the readout line Rₙ is coupled to the sensing unit 130 in the pixel P_{1,3} for sensing a touch control signal, such as an optical current, a contact voltage or a contact current. The readout lines Rₙ, Rₙ₊₁, Rₙ₊₂ . . . can be connected to a processor, IC or other control device without being connected to the source driver 12 to process the touch control signal. In addition, as mentioned above a gate line Gₙ₊₁ is coupled to the pixels P_{1,1} and P_{1,3}, and another gate line Gₙ₊₂ is coupled to the pixels P_{1,2} and P_{1,4}. That is, in the present invention two pixels disposed adjacent to a data line are coupled to the same data line but coupled to different gate lines.

A rule of determining which of the two pixels adjacent to a readout line is coupled to the readout line is that when one of the two pixels adjacent to the readout line is a blue sub-pixel, the readout line is coupled to the blue sub-pixel (for example in this embodiment the pixel P_{1,3} is a blue sub-pixel); and when one of the two pixels adjacent to the readout line is a green sub-pixel, the readout line is not coupled to the green sub-pixel but coupled to the other sub-pixel, e.g. coupled to a red sub-pixel or a blue sub-pixel. The reason is that the pixel being coupled to the readout line includes a sensing unit 130 such that the aperture ratio of the pixel will be decreased. Therefore, it is preferable to select the sub-pixel to which human eyes are relatively less sensitive to be coupled to the readout line so as to reduce the impact of the decrease of the aperture ratio.

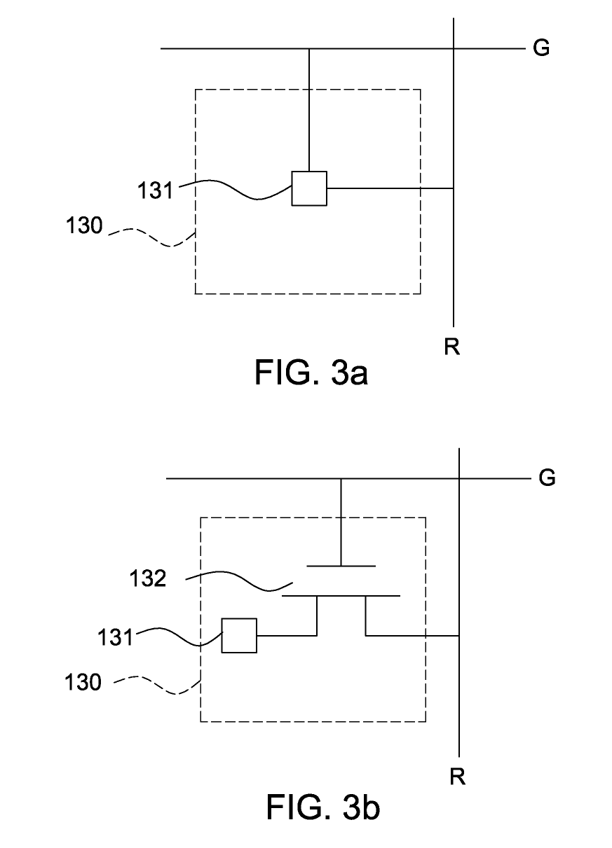

As mentioned above, the pixel to which a readout line is coupled, e.g. the pixel P_{1,3} to which the readout line Rₙ is coupled includes a sensing unit 130 coupled to the readout line, wherein the sensing unit 130 is also coupled to a gate line and under the control thereof so as to output a touch control signal to the readout line. The sensing unit 130 is configured to sense, for example, a voltage variation (e.g. in a resistive touch panel or a contact type touch panel), a current variation (e.g. in a capacitive touch panel), a light intensity variation (e.g. in an optical touch panel) or a wave intensity variation (e.g. in an acoustic wave touch panel). For example, if the touch panel 10 is an in-cell optical touch panel, the sensing unit 130 may include a touch sensor 131 therein as shown in FIG. 3a and the touch sensor 131 may be a light sensor such as a thin film transistor, a photo diode or a light sensitive resistor, but the present invention is not limited to these. If the touch panel 10 is an in-cell contact type touch panel (or called in-cell resistive touch panel), the touch sensor 131 in the sensing unit 130 may be, for example a contact type structure with or without a switching component (active component). As the structure of the contact type sensing unit is well know to the art, details thereof will not be repeated herein. It is noted that when the sensing unit 130 is a contact type structure without a switching component, the sensing unit 130 is not required to be coupled to a gate line as shown in FIGS. 2a, 2b and 3a.

Furthermore, as shown in FIG. 3b no matter the touch panel 10 is an optical type structure or a contact type structure, besides a touch sensor 131 the sensing unit 130 may further include a switching component (active component) such as a read transistor (or so called switching transistor) 132, wherein the read transistor 132 is coupled to between the readout line R and the touch sensor 131 to control whether to output a touch control signal to the readout line R. The read transistor 132 may be a thin film transistor under the control of a gate line G coupled thereto.

As mentioned above, for example referring to FIGS. 3a to 3b, a sensing unit 130 may include a touch sensor 131 directly coupled to a readout line R and a gate line G, or may further include a read transistor 132 coupled to a readout line R and a gate line G, and the touch sensor 131 may send the touch control signal to the readout line R through the read transistor 132.

In the first embodiment, as the readout lines R are disposed only between a part of adjacent pixels without a data line disposed therebetween, a higher aperture ratio can be realized. More specifically speaking, in this embodiment, preferably as shown in FIGS. 2a and 2b, the readout lines R are respectively disposed in a part of the spaces between adjacent pixel electrodes 17 and no data line is disposed in the space having a readout line R therein. A distance between the readout line R and the data line D adjacent to each other is at least larger than a pixel electrode width W′ of the pixel electrode 17 and less than a pixel width W or equal to a pixel width W. In addition, in the same pixel, e.g. the pixel P_{1,3} shown in FIGS. 2a and 2b, a relative position between the sensing unit 130 and the pixel transistor 14 does not have any specific limitation. Although in this embodiment the sensing unit 130 and the pixel transistor 14 are disposed at diagonal positions and coupled to different gate lines Gₙ₊₁ and Gₙ₊₂, the sensing unit 130 and the pixel transistor 14 may be coupled to the same gate line Gₙ₊₁ in another embodiment, but the present invention is not limited to these.

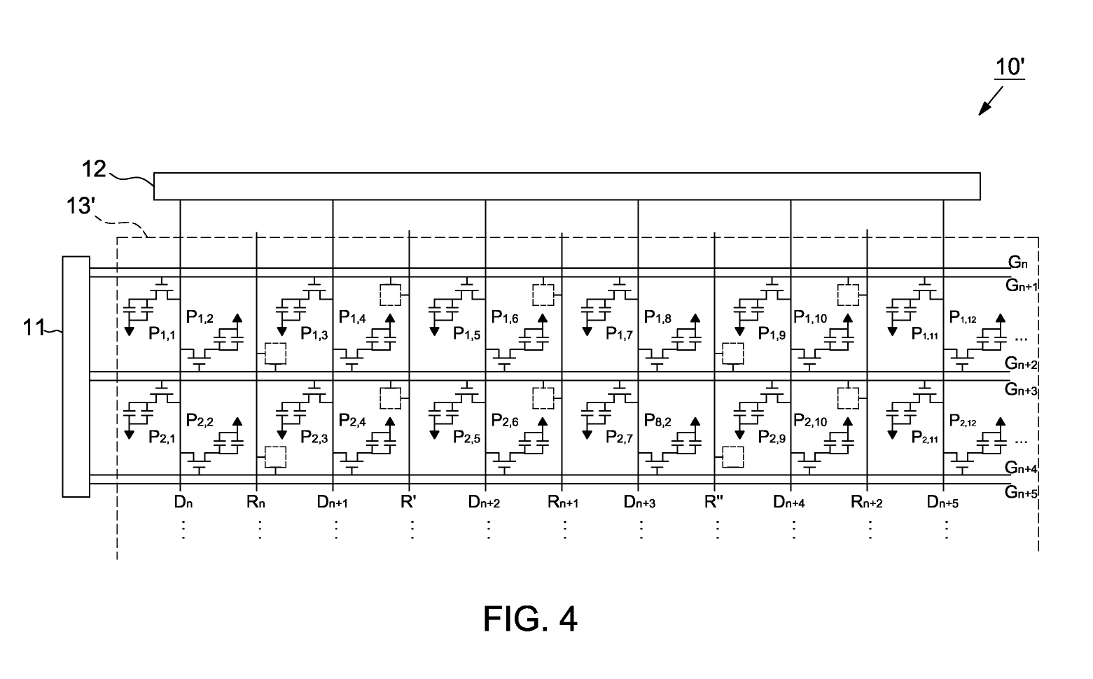

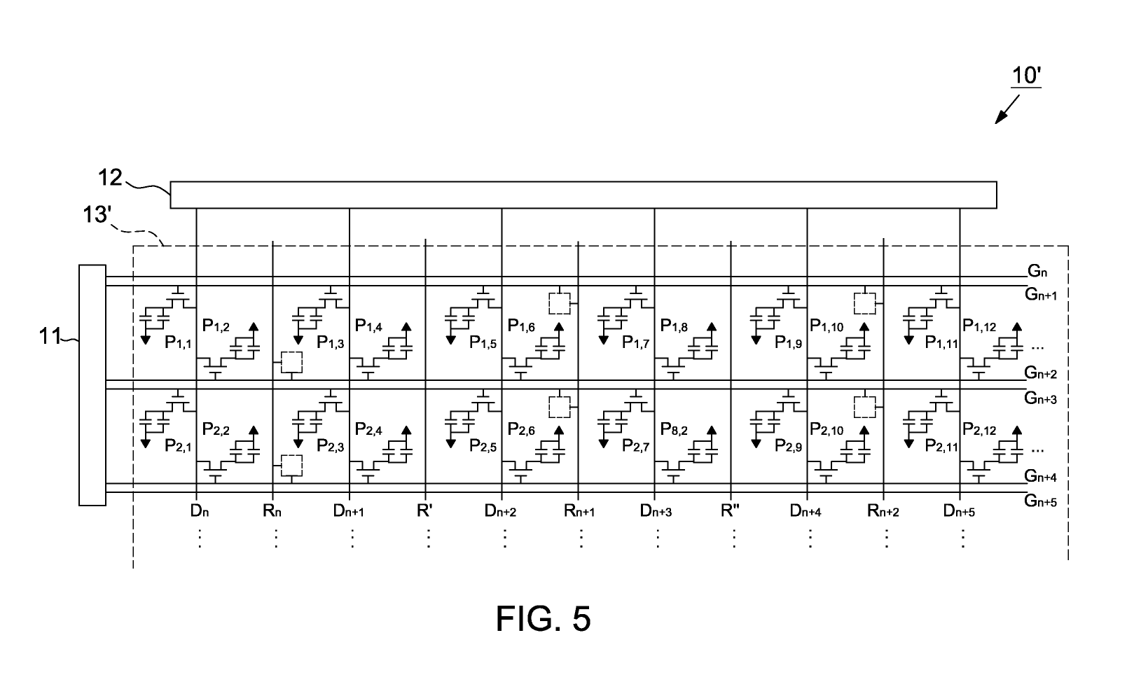

Please refer to FIGS. 4 to 5, they show schematic diagrams of the touch panel 10′ according to the second embodiment of the preset invention. The touch panel 10′ includes a gate driver 11, a source driver 12 and a pixel array 13′. The difference between this embodiment and the first embodiment is that, the readout lines are disposed between all adjacent pixels (or all adjacent pixel electrodes) having no data line disposed therebetween. In an aspect, all readout lines are coupled to one of the two pixels adjacent thereto, so the second embodiment will improve the detection resolution of the touch panel 10′ (as shown in FIG. 4). In another aspect, in FIG. 5, only a part of the readout lines R (e.g. Rₙ, Rₙ₊₁ and Rₙ₊₂ shown) are coupled to one of the two pixels adjacent thereto and the other part of readout lines R (e.g. R′ and R″ shown in FIG. 5) are not coupled to adjacent pixels, that reduces the coupling effect between two adjacent pixels to eliminate the potential fluctuation due to the voltage leakage thereby increasing the uniformity of the display.

In the pixel array 13′, a data line and a readout line are alternatively disposed between every two adjacent pixels along a horizontal direction, such as a data line Dₙ is disposed between the pixels P_{1,1} and P_{1,2}; a readout line Rₙ is disposed between the pixels P_{1,2} and P_{1,3}; a data line Dₙ₊₁ is disposed between the pixels P_{1,3} and P_{1,4}; a readout line Rₙ′ is disposed between the pixels P_{1,4} and P_{1,5}; a data line Dₙ₊₂ is disposed between the pixels P_{1,5} and P_{1,6}; a readout line Rₙ₊₁ is disposed between the pixels P_{1,6} and P_{1,7}; a data line Dₙ₊₃ is disposed between the pixels P_{1,7} and P_{1,8}; a readout line R″ is disposed between the pixels P_{1,8} and P_{1,9}; . . . , wherein the readout lines R′ and R″ may or may not be coupled to the sensing unit 130 in one of the two pixels adjacent thereto. For example, the readout line R′ is coupled to the sensing unit of the pixel P_{1,4} and the readout line R″ is coupled to the sensing unit of the pixel P_{1,9} in FIG. 4; while the readout line R′ is not coupled to the pixel P_{1,4} and the readout line R″ is not coupled to the pixel P_{1,9} in FIG. 5. In the pixel array 13′ of FIGS. 4 and 5, two pixels disposed adjacent to every data line Dₙ to Dₙ₊₅ are coupled to the same data line but coupled to different gate lines; for example, the pixels P_{1,1} and P_{1,2} are coupled to the data line Dₙ, the pixel P_{1,1} is coupled to the gate line Gₙ₊₁ and the pixel P_{1,2} is coupled to the gate line Gₙ₊₂. In addition, other features of this embodiment are similar to those of the first embodiment and thus details will be repeated herein. As mentioned above, a density of the sensing unit 130 of the touch panel in FIG. 4 is larger than that in FIG. 5 and thus the touch panel in FIG. 4 has a higher resolution in touch control.

In the second embodiment, as the readout lines are disposed between all adjacent pixels (or all adjacent pixel electrodes) having no data line disposed therebetween and a distance between adjacent data line and readout line is larger than a pixel electrode width W′ and less than a pixel width W or equal to a pixel width W, the coupling effect between adjacent pixels can be decreased thereby improving the uniformity of the display. In addition, since a data line and a readout line will not be disposed together between two adjacent pixels (or adjacent pixel electrodes), the present invention still has a higher aperture ratio than conventional in-cell touch panels.

Please refer to FIGS. 2 to 5, in a word the touch panel of the present invention includes a plurality of pixels arranged in a matrix, a plurality of gate lines, a gate driver coupled to the plurality of gate lines, a plurality of data lines and a plurality of readout lines. Every two pixels in a row along a horizontal direction may be referred as a pixel group, e.g. the pixels P_{1,1} and P_{1,2}, pixels P_{1,3} and P_{1,4} . . . , and each pixel is coupled to one gate line. The data lines are respectively disposed between two adjacent pixels of the pixel groups, e.g. the data line Dₙ is disposed between the pixels P_{1,1} and P_{1,2}, the data line Dₙ₊₁ is disposed between the pixels P_{1,3} and P_{1,4} . . . , wherein two adjacent pixels of each pixel group are coupled to the same data line but coupled to different gate lines, e.g. both the pixels P_{1,1} and P_{1,2} are coupled to the data line Dₙ; both the pixels P_{1,3} and P_{1,4} are coupled to the data line Dₙ₊₁ . . . ; the pixel P_{1,1} is coupled to the gate line Gₙ₊₁; the pixel P_{1,2} is coupled to the gate line Gₙ₊₂; the pixel P_{1,3} is coupled to the gate line Gₙ₊₁; and the pixel P_{1,4} is coupled to the gate line Gₙ₊₂ . . . . Furthermore, the readout lines are disposed between at least a part of two adjacent pixel groups, for example in FIGS. 2a and 2b the readout lines are disposed between a part of two adjacent pixel groups (or two adjacent pixel electrodes) having no data line disposed therebetween. However, in FIGS. 4 and 5 the readout lines are disposed between all two adjacent pixel groups (or two adjacent pixel electrodes) having no data line disposed therebetween, and at least a part of the readout lines are coupled to one of the two pixels adjacent thereto. For example in FIG. 4 all readout lines are coupled to the sensing unit 130 in one of the two pixels adjacent thereto; while in FIG. 5 only a part of the readout lines are coupled to the sensing unit 130 in one of the two pixels adjacent thereto.

As mentioned above, conventional in-cell touch panels have the problem of having a lower pixel aperture ratio. The present invention further provides a touch panel and pixel array thereof (FIGS. 2a, 2b, 4 and 5) that may improve the aperture ratio of a touch panel and reduce the coupling effect between adjacent pixels such that the present invention may be applicable to all in-cell touch panels that have sensing units integrated inside the liquid crystal panel.

Although the invention has been explained in relation to its preferred embodiment, it is not used to limit the invention. It is to be understood that many other possible modifications and variations can be made by those skilled in the art without departing from the spirit and scope of the invention as hereinafter claimed.

What is claimed is:

1. A pixel array of a touch panel, comprising:
a first pixel, a second pixel, a third pixel and a fourth pixel sequentially arranged along a horizontal direction;
a first data line extending along a vertical direction, disposed between and coupled to the first pixel and the second pixel;
a second data line extending along the vertical direction, disposed between and coupled to the third pixel and the fourth pixel;
a readout line extending along the vertical direction, disposed between the second pixel and the third pixel, and coupled to at least one of the second pixel and the third pixel, wherein no data line is disposed between the second pixel and the third pixel;
a first gate line coupled to the first pixel and the third pixel; and
a second gate line coupled to the second pixel and the fourth pixel.

2. The pixel array as claimed in claim 1, wherein the pixel to which the readout line coupled further comprises a sensing unit coupled to the readout line for outputting a touch control signal.

3. The pixel array as claimed in claim 2, wherein a distance between the readout line and the first data line and a distance between the readout line and the second data line are larger than a pixel electrode width and equal to a pixel width.

4. The pixel array as claimed in claim 2, wherein the sensing unit comprises a read transistor and a touch sensor, and the read transistor is coupled to the readout line and a corresponding gate line, and the touch sensor is coupled to the read transistor.

5. The pixel array as claimed in claim 2, wherein each pixel further comprises a pixel transistor coupled to a corresponding gate line, and in the pixel to which the readout line coupled the pixel transistor and the sensing unit are respectively coupled to different gate lines.

6. The pixel array as claimed in claim 1, wherein when one of the second pixel and the third pixel is a blue sub-pixel, the readout line is coupled to the blue sub-pixel; while when one of the second pixel and the third pixel is a green sub-pixel, the readout line is not coupled to the green sub-pixel.

7. A pixel array of a touch panel, comprising:
a plurality of pixels arranged in a matrix;
a plurality of data lines disposed along a horizontal direction;
a plurality of readout lines disposed parallel to the data lines; and
a plurality of gate lines disposed perpendicular to the data lines;
wherein a data line and a readout line are alternatively disposed between every two adjacent pixels along the horizontal direction; two pixels adjacent to each data line are coupled to the same data line but coupled to different gate lines; and at least a part of the readout lines are coupled to one of the two pixels adjacent thereto.

8. The pixel array as claimed in claim 7, wherein the pixel adjacent to the readout line and coupled thereto further comprises a sensing unit coupled to the readout line for outputting a touch control signal.

9. The pixel array as claimed in claim 8, wherein the sensing unit is configured to sense a voltage variation, a current variation, a light intensity variation or a wave intensity variation.

10. The pixel array as claimed in claim 8, wherein the sensing unit comprises a read transistor and a touch sensor, and the read transistor is coupled to the readout line and a corresponding gate line, and the touch sensor is coupled to the read transistor.

11. The pixel array as claimed in claim 8, wherein each pixel further comprises a pixel transistor coupled to a corresponding gate line, and in the pixel to which the readout line coupled the pixel transistor and the sensing unit are respectively coupled to different gate lines.

12. The pixel array as claimed in claim 7, wherein when one of the two pixels adjacent to the readout line is a blue sub-pixel, the readout line is coupled to the blue sub-pixel; and when one of the two pixels adjacent to the readout line is a green sub-pixel, the readout line is not coupled to the green sub-pixel.

13. The pixel array as claimed in claim 7, wherein all of the readout lines are coupled to one of the two pixels adjacent thereto.

14. A touch panel, comprising:
a plurality of pixels arranged in a matrix, wherein every two pixels in a row along a horizontal direction form a pixel group;
a plurality of gate lines, wherein each pixel is coupled to one of the gate lines;
a gate driver coupled to the gate lines;
a plurality of date lines respectively disposed between two pixels of the pixel group, wherein the two pixels of each pixel group are coupled to the same data line but coupled to different gate lines; and
a plurality of readout lines disposed between at least a part of two adjacent pixel groups, wherein a data line and a readout line are alternatively disposed between every two adjacent pixels along the horizontal direction, and at least a part of the readout lines being coupled to one of the two pixels adjacent thereto.

15. The touch panel as claimed in claim 14, wherein the readout lines are respectively disposed between all adjacent pixel groups.

16. The touch panel as claimed in claim 14, wherein the pixel adjacent to the readout line and coupled thereto further comprises a sensing unit coupled to the readout line for outputting a touch control signal.

17. The touch panel as claimed in claim 16, wherein the sensing unit is configured to sense a voltage variation, a current variation, a light intensity variation or a wave intensity variation.

18. The touch panel as claimed in claim 16, wherein the sensing unit comprises a read transistor and a touch sensor, and the read transistor is coupled to the readout line and a corresponding gate line, and the touch sensor is coupled to the read transistor.

19. The touch panel as claimed in claim 16, wherein each pixel further comprises a pixel transistor coupled to a corresponding gate line, and in the pixel to which the readout line coupled the pixel transistor and the sensing unit are respectively coupled to different gate lines.

20. The touch panel as claimed in claim 14, wherein when one of the two pixels adjacent to the readout line is a blue sub-pixel, the readout line is coupled to the blue sub-pixel; and when one of the two pixels adjacent to the readout line is a green sub-pixel, the readout line is not coupled to the green sub-pixel.
